(19) United States
(12) Patent Application Publication
(10) Pub. No.: US 2026/0100910 A1
(43) Pub. Date: Apr. 9, 2026

(54) PRODUCING AN INDICATOR FOR SPECIFYING THE QUALITY OF A DATA TRANSMISSION

(71) Applicant: AUDI AG, Ingolstadt (DE)

(72) Inventors: Kerstin BASKAKOW, Sappenfeld (DE); Christian RÖTTINGER, Ingolstadt (DE)

(73) Assignee: AUDI AG, Ingolstadt (DE)

(21) Appl. No.: 19/114,058

(22) PCT Filed: Sep. 13, 2023
(86) PCT No.: PCT/EP2023/075196

§ 371 Date: Mar. 21, 2025

(30) Foreign Application Priority Data
Sep. 22, 2022 (DE) 10 2022 124 382.6

(51) Int. Cl. H04L 47/24; H04L 47/34

(52) U.S. Cl. CPC H04L 47/24; H04L 47/34

(57) ABSTRACT

The invention relates to generation of an indicator for indicating quality of a wireless data transmission between a transmitter, and a receiver coupled thereto. In the method, a processing signal is detected, which comprises one or more messages indicating a state of a respective functional unit of the transmitter. The one or more messages are provided by the respective functional unit with a predetermined periodicity or regularity. A receiver message count is determined, indicating a number of messages transmitted to the receiver. The receiver message count is verified to determine whether the receiver message counter matches a predefined reference message count, which is obtained as a function of the aforementioned periodicity. Depending on the outcome of the verification, the data transmission quality indicator is provided.

### CROSS REFERENCE TO RELATED APPLICATIONS

This application is a U.S. national stage of International Application No. PCT/EP2023/075196, filed on Sep. 13, 2023. The International Application claims the priority benefit of German Application No. 10 2022 124 382.6 filed on Sep. 22, 2022. Both the International Application and the German Application are incorporated by reference herein in their entirety.

### BACKGROUND

### 1. Field

Disclosed herein is a method for generating an indicator for indicating the quality of a wireless data transmission between a transmitter and a receiver coupled thereto. The disclosure also relates to a data processing device for carrying out a corresponding method, and a receiver and a transmitter having such a data processing device. Finally, the disclosure also relates to a system having such a transmitter and such a receiver.

### 2. Description of the Related Art

In an electrical network, as is known for example from an on-board electrical network of a vehicle, a so-called BUS system can be used, for example, to communicate with individual network subscribers. At present, different types or kinds of BUS systems are used. These differ, for example, in the interconnection of the subscribers and, for example, in the type of standardized communication protocol used for data transmission. In the automotive sector, known BUS types include the CAN BUS (Controller Area Network), the LIN BUS (LIN: Local Interconnect Network), Ethernet or FlexRay, to name just a few examples.

For example, signals or data can be exchanged between two subscribers, such as control units of the motor vehicle, via a common transmission path. The transmission can take place in particular unidirectionally or bidirectionally, depending on the BUS type. For example, the data comprises one or more messages that describe or indicate a state or property of the respective subscriber. For example, a vehicle door control unit can transmit the message “Door open” or “Door closed” as a state to a vehicle central on-board computer. Similarly, for example, the central on-board computer can transmit a setpoint torque to a powertrain control unit of the motor vehicle as a message.

Preferably, the data transmission is clocked or takes place periodically in the form of a message signal. In this case multiple messages are sent sequentially or in chronological sequence. The transmission takes place with a predetermined periodicity, i.e. at predetermined time intervals. The periodicity can depend on the respective subscriber, in particular its position in the network for security relevance. For example, if multiple subscribers are connected to each other via a common data line, this can be used to ensure that no two messages from different subscribers are transmitted simultaneously. The periodicity or cycle time is typically in the range of a few milliseconds to several seconds, for example. In particular, the periodicity can be between 20 milliseconds and 1,000 milliseconds, for example.

Transmission errors can occur in internal communication on such a network. For example, individual messages can be lost due to network faults.

In order to detect errors in data transmission, a central control unit for redundant communication is known from WO 2008/017441 A1, for example. The central control unit is connected to a drive control unit via two communication paths. This is used to assign the setpoint torque by assigning the same message counter and a respective checksum. The correct transmission of the setpoint torque can be checked based on the correspondence of the message counter and the equality of the checksum.

The disadvantage of this method is that additional material and installation space must be provided for the redundant communication path. This can increase production and development costs.

Document WO 2010/112 327 A1 discloses a method of providing a high level of data security in vehicle-to-vehicle communication. The method checks whether received messages exchanged between the vehicles comply with certain rules. For this purpose, it can be checked, for example, whether the number of received data packets per unit time complies with the rules

In modern vehicles, for example, external communication is also used in addition to internal communication. For example, certain data may be exported or forwarded to a backend, such as a server outside the vehicle, for processing. For example, a so-called ODC (Online Data Collector) is used in the vehicle. This can collect the message signals from the control units, for example, and prepare them for forwarding to the backend.

However, the ODC may be limited in terms of its resources and performance, so that only an amount of data that differs, for example, from software version to software version can be securely exported. In addition, the ability of the ODC to cache data may be limited, for example in the event that there is no wireless communication connection available, such as a mobile radio connection, to the backend.

It can happen that a limiting load of the “ODC” system cannot be determined safely in advance in the vehicle. This can happen, for example, if there are a large number of software versions (for example, a new software version for each vehicle model) and a large number of variants of the software version for each vehicle model. There may also be utilization limits in the communication link to the backend or in the backend itself. As a result, data export or data transmission may not operate in a stable manner, at least in part, or the data quality for further processing may not be sufficiently guaranteed.

### SUMMARY

An aspect of the invention is directed to feature(s) to provide an indicator for reliably and cost-effectively indicating the quality of a wireless data transmission between a transmitter and a receiver coupled thereto, which can be used to test the quality of a data transmission over a respective data path.

An aspect of the invention is based on the recognition that by skillful exploitation of the periodicity of already existing signals, such as the aforementioned message signal, in a transmitter, such as the aforementioned vehicle, a corresponding indicator can be generated particularly simply. This enables the utilization of the data link to be detected and, for example, the processing of the transmitted data to be adapted.

For this purpose, according to one aspect, the invention proposes a method for generating an indicator for indicating a goodness rating, for example, a quality or integrity, of a wireless data transmission between a transmitter and a receiver coupled thereto, in particular wirelessly. For example, the transmission quality of a motor vehicle as a transmitter and a backend as a receiver can be determined. The method comprises operation(s), which can be carried out, for example, by a data processing device.

First, a processing signal is detected, which can be transmitted, that is, for example, has been transmitted or will be transmitted, from the transmitter to the receiver for processing by the receiver. In this case, processing can mean, for example, evaluation, preparation and/or caching. This processing signal is provided by a data collection unit, such as an Online Data Collector (ODC) of the transmitter mentioned earlier. This means that the data collection unit can generate and transfer the processing signal. To provide the processing signal, the data collection unit can, for example, acquire a respective message data set of at least one functional unit of the transmitter. This means that the data collection unit is designed or configured for this purpose.

The respective message data set comprises at least one message, which in particular indicates, i.e. describes or codes, a time-dependent current state, i.e., for example, a property of the respective functional unit. The message data set can thus be, for example, a portion or extract of the message signal, which is used in the transmitter for communication between two functional units. In the automotive sector, for example, the functional units may be, for example, respective control units, such as a central computing unit and a drive control unit or a door control unit. Preferably, the message data set comprises a data packet with at least two periodically consecutive or chronologically consecutive messages. Preferably, associated message information, such as a clock time and/or other relevant meta-information relevant to the message may also be included.

Each message therefore involves data that is to be transmitted wirelessly from the transmitter to the receiver device by the processing signal. This may result in the complete or partial loss of individual messages or a message data set if the transmission takes place under certain conditions. This can happen, for example, if a communication link to the data collection unit or between transmitter and receiver is interrupted, or if the data collection unit or the transmitter or receiver has reached or exceeded a maximum computing power, i.e. its respective utilization limit.

In order to detect such a malfunction in the data transmission, the method provides that a current receiver message count is determined depending on the number of messages of the respective message data set transmitted to the receiver. The purpose of this is to determine how many messages have already been transmitted or made available for transmission using a particular processing signal. This means that the receiver message count can comprise or include in the count the messages from previous transmissions in addition to the current messages in the current processing signal, if, for example, multiple transmissions have already taken place. The receiver message count thus indicates a total number of messages that have been exchanged or scheduled for exchange between the transmitter and receiver within a predetermined data transmission period. The data transmission period may be bounded, for example, by a start signal and a respective end signal provided by the transmitter. For example, these can be assigned to a start or an activation or deactivation of the transmitter.

The method then checks whether the receiver message count corresponds to a predetermined reference message count according to a predetermined verification criterion. The reference message count in this case is obtained as a function of a previously known periodicity or repetition rate of successive messages, which are provided, in particular sent or transmitted, by the assigned functional unit periodically, that is, in predetermined time intervals, for example by the message signal in the transmitter. As described earlier, this type of periodic message transmission occurs in particular in functional units that are coupled by a BUS system.

In the method, the indicator indicating the quality of the data transmission of the processing signal is then provided in accordance with the outcome of the verification. The indicator thus gives an indication of whether a data transmission between the transmitter and receiver device that has already been completed or is still pending or scheduled can function correctly. Which part of the transmission link can be checked by the described method depends, for example, on whether the transmitter or the receiver carries out the above method. This will be discussed in more detail later.

The described method can be used both in the validation or testing stages as well as in the field, i.e. in the transmitters and receivers used by the end user. Overall, this allows continuous inspection or monitoring of the quality of data collection or data transmission. The indicator can also be used to ensure that the respective system, i.e., for example, the receiving or transmitting device or the data collection unit, is not operated or loaded beyond its respective performance limit. For example, it can prevent certain services, such as Connect services, from being compromised. In addition, the indicator can be used, for example, to make even more granular decisions as to which data is still usable for further processing and which data is, for example, data garbage or may give rise to erroneous conclusions in processing.

The described method can be implemented, for example, as program code in an already existing data processing device of the transmitter or the receiver. This has the advantage that any transmitting or receiving device can be retrofitted with the appropriate function, so that, for example, the data transmission can be checked for matching or consistency of content, regardless of the software version of the data collection unit.

In other words, the periodicity or cycle time may be known for each functional unit or for each message signal of the transmitter. This makes it possible to additionally count how many messages should be included or present per data set that is transmitted or to be transmitted. This means that the method can check whether or not a message data set provided by the transmitter or its functional unit corresponds to a message data set which is received by the receiver or to be transmitted to it, by comparing the aforementioned message counts. If messages or parts of the data sets were lost during the transmission or preparation of the transmission, this can be indicated by the indicator.

The periodicity of the data transmission in the transmitter is exploited for this purpose. The periodicity refers to the regularity of the successive messages that are transmitted or expected in a message signal. This type of periodic message transmission is typical of the BUS communication described above. This means that the messages can be transmitted in the transmitter in the form of BUS signals, i.e. by a BUS system. For example, the transmission can be carried out via a CAN or LIN BUS or Ethernet or FlexRay.

The periodicity can be made into a comparable quantity using message counts. The respective message count is a numeric value, which is incremented with each message, for example, by exactly 1. The message count can therefore be a test value or, for example, a checksum, which can be used to validate the correctness of the data transmission.

For example, the message count can be coded according to a predefined counting scheme. In this way, at normal message transmission rates from a few milliseconds to a few microseconds, as are commonly used in a BUS system, it is possible to avoid infinitely high message counts being reached. For example, the respective message count can be limited to a maximum value and can be reset to a starting value when the maximum value is reached. For example, the counter can be incremented periodically between 0 and 15 or 0 and 255 for each message, with the counter being incremented by 1 for each message. Once the maximum value of 15 or 255 is reached, the counter is reset to the starting value of 0.

The outcome of the message count comparison can be the above-mentioned indicator, i.e. a characteristic value that indicates the consistency or completeness of the transmitted data. For example, the indicator can be classified or categorized as negative or positive. For example, a positive indicator can mean correct or error-free data transmission. A negative indicator, on the other hand, can mean, for example, that the data transmission contains errors or is incorrect. In particular, for example, a positive indicator can be output only if the verification is positive, i.e. the message counts match. In contrast, for example, a negative indicator that symbolizes the erroneous data transmission can be provided only if the verification is negative, i.e. if the message counts differ from each other.

The generated indicator can be used, for example, to trigger an error message or error warning, in particular if a negative indicator is provided. On the basis of the error message, for example, those messages that were included in the erroneous data transmission can be transmitted again. Alternatively, this data can be marked as containing errors, for example. In addition or alternatively, this data can also be deleted or discarded, for example.

The invention also includes embodiments which result in additional examples.

According to one embodiment, the reference message count is determined by the transmitter. The reference message count is included in the processing signal for transmission to the receiver. This means that the reference message count is transmitted to the receiver as part of the processing signal.

According to a further embodiment, the reference message count value is determined by the receiver. The determination is carried out in this case depending on a previously known start time of the beginning of a message transmission by the assigned functional unit in the transmitter and on a previously known packet size, which indicates the number of transferred messages in the processing signal. The beginning of the message transmission in this case refers in particular to the beginning of the aforementioned data transmission period. In addition or alternatively, for example, it may also refer to a point in time in the data transmission period when the respective functional unit provides the first message. The packet size in this case refers in particular to the size or extent of the respective message data set. The packet size thus specifies the maximum number of messages contained in the message data set. For example, the packet size can be set or predefined to a default size. The start time and the packet size can be transferred, for example, from the transmitter to the receiver in the processing signal.

The two embodiments described above are particularly relevant when the method is to be carried out by the receiver. This can provide a particularly simple way to detect the reference message count for the receiver.

According to a further embodiment, the respective message count, in particular the receiver message count and/or the reference message count, is formed as a sum of a predetermined number of messages. The message count can thus be used as a checksum for the messages.

According to a further embodiment, the respective message count is formed as a mean value of a sum of a predetermined number of messages. This means that the respective message counts are examined, for example, for a specific period or time interval.

The number of messages examined can be chosen depending on the aforementioned counting scheme, for example. For example, the sum can be generated over a window or a range of 16 or 256 consecutive messages. Due to the periodic sequence of the message counter, it does not matter where and when the counting starts, as long as the summation is made or the mean value is formed over the range or the selected period. For values from 0 to 15 for the message counter, the sum must equal 120 or the mean value must equal 7.5 if no messages have been lost during acquisition or processing.

Alternatively, it can of course be provided that current values of the respective message counts are compared with one another. This means that it is possible to check whether the message count that existed when the reference signal was prepared for transmission or transmitted matches the message count that was received or prepared for transmission.

For use cases or application situations that may arise in the method and which are not explicitly described here, it may be provided according to the method that an error message and/or a prompt to input user feedback is output and/or a default setting and/or a predetermined initial state is set.

According to a further aspect, the invention also relates to a data processing device for generating an indicator for indicating the quality of a wireless data transmission between the transmitter and the associated receiver. In this case, the data processing device is designed to carry out or execute a method as has been previously described.

The data processing device can comprise, for example, a control device or processor device, which is configured to carry out an embodiment of the method according to the invention. For this purpose, the processor device may comprise at least one microprocessor and/or at least one microcontroller and/or at least one FPGA (field programmable gate array) and/or at least one DSP (digital signal processor). Furthermore, the processor device can have program code which is configured, when executed by the processor device, to carry out the embodiment of the method according to the invention. The program code can be stored in a data memory of the processor device. A processor circuit of the processor device may comprise, for example, at least one circuit board and/or at least one SoC (system on chip).

According to a further aspect, the invention also relates to a receiver having a data processing device as described above. The data processing device is designed to receive the processing signal from the transmitter by wireless data transmission. Thus, a data link or data transmission in the transmitter as well as on a transmission path between transmitter and receiver can be checked.

The receiver in the present case may be, for example, a vehicle-external data storage device. For example, it can be a so-called backend or a so-called server, in particular a cloud server.

According to a further aspect, the invention also relates to a transmitter having at least one functional unit and a data processing device, as described above. The data processing device can comprise a data collection unit for providing the processing signal or at least be associated with it. The data collection unit is designed to acquire a respective message data set of the respective functional unit in order to provide the processing signal. The transmitter is also designed to transmit the processing signal to the receiver by wireless data transmission. This allows the data link or data transmission to be checked in the transmitter before sending the processing signal to the receiver.

The transmitter is preferably designed as a motor vehicle or motor car. It may in particular be a passenger car or lorry or a passenger bus or a motorcycle.

For example, the functional unit of the transmitter can be a control unit. The transmitter can comprise a plurality of functional units. In the motor vehicle system, the functional unit may be, for example, a door control unit or motor control unit or a drive control unit or a central computing unit or another conventional control unit, such as used in the automotive sector. The functional units of the transmitter can differ from the data collection unit or the data processing device, for example, in that the functional units are designed only for the transmitter-internal communication or data transmission. In contrast, the data collection unit and/or the data processing device for data transmission can be designed for data transmission externally to the vehicle.

The functional units are particularly preferably, for example, only safety-relevant control units. This means control units that are responsible for functional safety of the transmitter, for example. In a motor vehicle, for example, they may be control units involved in steering or braking, or ones that implement other functions necessary for a traffic approval. A distinction must be made between non-safety-relevant functional units, such as comfort-related consumers in the vehicle, and the safety-relevant control units.

According to a further aspect, the invention also relates to a system having a transmitter and a receiver, which are coupled to each other for data transmission in a wireless communication link. The receiver is designed as a receiver as previously described. In addition or alternatively, the transmitter is also designed as a transmitter as previously described.

This means that either the transmitter and the receiver or only the transmitter or only the receiver can comprise the aforementioned data processing device. The aforementioned method for generating the indicator can thus be carried out either using one of the two devices (transmitter or receiver), or using both devices.

The processing signal can thus be provided as a wireless signal, radio signal or cordless signal. In order to implement the cordless data transmission, the transmitter and receiver can be connected or coupled by a wireless communication interface. In this case, the sender and the receiver can each have a corresponding communication unit. This allows the transmitter and receiver to be connected to each other in the wireless communication connection. For example, the communication link can be a connection based on WLAN, Bluetooth, radio, in particular mobile radio. The respective communication unit can therefore be, for example, an antenna module or radio module.

An aspect of the invention also includes refinements of the data processing device, the receiver, the transmitter and the system, which have features such as have already been described in connection with the refinements of the method according to the invention. For this reason, the corresponding refinements of the data processing device, the receiver, the transmitter and the system are not described again here.

An aspect of the invention also includes the combinations of the features of the embodiments described. The invention thus also includes realizations which each have a combination of the features of several of the embodiments described, provided that the embodiments were not described as mutually exclusive.

### BRIEF DESCRIPTION OF THE DRAWINGS

These and other aspects and advantages will become more apparent and more readily appreciated from the following description of the exemplary embodiments, taken in conjunction with the accompanying drawings of which:

Exemplary embodiments of the invention are described in the following. In the drawings:

FIG. 1 shows a schematic representation of a system in which the quality of a data transmission between a transmitter and a receiver is determined by a data processing device according to an aspect of the invention; and

FIG. 2 shows a schematic representation of a method flowchart for operating the data processing device according to an aspect of the invention.

### DETAILED DESCRIPTION

Reference will now be made in detail to the preferred embodiments, examples of which are illustrated in the accompanying drawings, wherein like reference numerals refer to like elements throughout.

The exemplary embodiments described in the following relate to preferred embodiments of the invention. In the exemplary embodiments, the described components of the embodiments each represent individual features of the invention, which are to be considered independently of each other, and which in each case also further develop the invention independently of each other. Therefore, the disclosure is also intended to include combinations of the features of the embodiments other than those presented. Furthermore, the embodiments described can also be extended to include other features of the invention already described.

In the figures, identical reference signs designate functionally equivalent elements.

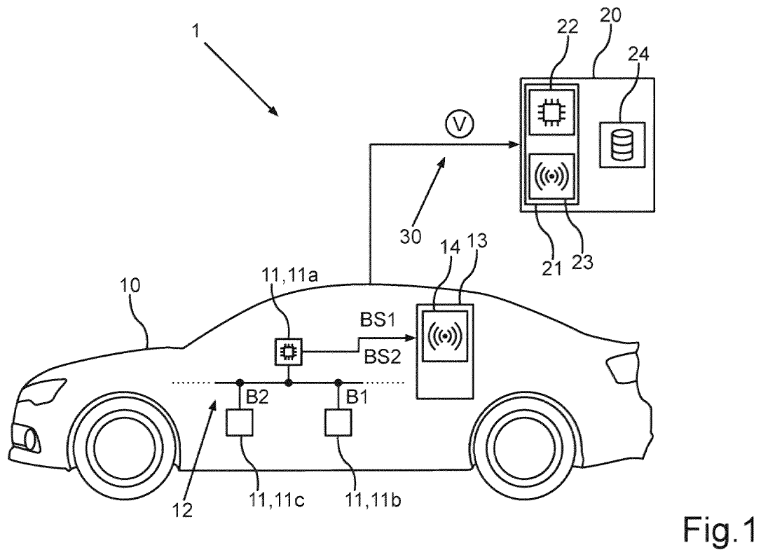

FIG. 1 shows a schematic illustration of a system 1. The system 1 comprises a motor vehicle 10 as a transmitter and a backend server 20 external to the vehicle as a receiver.

The motor vehicle 10 comprises a plurality of functional units 11, which in this case are formed by control units of the motor vehicle 10 for carrying out a predetermined vehicle function. A functional unit 11 may be, for example, a central computing unit 11a of the motor vehicle, that is, for example, a CPU or a central on-board computer. The remaining two functional units 11 may be, for example, a door control unit 11b and a drive control unit 11c. The functional units 11 are connected to each other in an electrical network or on-board network by a BUS system 12. For example, this can be a CAN-BUS system. The BUS system 12 specifies both the topology of the connection between the functional units 11 and a communication according to a predetermined communication protocol for data transmission between the functional units.

In the present case, the BUS system 12 can specify, for example, a master-slave configuration of the functional units 11 that is known per se. In this case, the central computing unit 11a may comprise, for example, a master control unit, while the remaining two functional units 11 comprise so-called slave control units. The central computing unit 11a thus controls access to the common transmission path, in this case the respective data line for connecting the door control unit 11b and the drive control unit 11c to the central computing unit 11a.

Communication between the functional units 11 may comprise, for example, the transmission of messages. For example, the messages can indicate a state or status of the respective functional unit 11. For example, the drive control unit 11c can provide an actual rotation speed of a motor to the central computing unit 11a as a message. The door control unit 11b can transmit, for example, a state of the vehicle door, such as “Door open” or “Door closed”, as a message. The respective messages of the functional units 11 are transmitted in the form of periodic message signals B1, B2. This means that the respective messages are sent in the assigned message signal B1, B2 in a clocked manner or periodically, i.e. consecutively in predetermined time cycles. In the present case, the message signal B1 is assigned to the door control unit 11b, for example. The message signal B2 is assigned to the drive control unit 11c, for example. A cycle time or periodicity in which messages are transmitted by the first message signal B1 can be, for example, 1,000 milliseconds. In contrast, the periodicity between messages transmitted in the message signal B2 can be 20 milliseconds.

The central computing unit 11a can detect the message signals B1, B2 and, for example, further process them, i.e. evaluate them, for example. The result of the evaluation can be used by the central computing unit 11a, for example, to control the control units 11b, 11c. For example, the central computing unit 11a can specify a setpoint rotation speed for the motor to the drive control unit 11c.

In order to optimize data processing, the message signals B1, B2 or the respective messages can alternatively or additionally be further processed externally to the vehicle, for example by the backend server 20. This can, for example, evaluate the message signals and send them back to the motor vehicle 10 in evaluated form to provide the control, or cache them for later retrieval, for example.

For external processing, the central computing unit 11a can, for example, also combine one or more messages of the respective message signal B1, B2 in a message data set BS1 and BS2 and thus prepare them for processing by the backend server 20. In the present case, the message data set BS1 may comprise, for example, only messages of the message signal B1, while the message data set BS2 comprises only messages of the message signal B2. For example, the number of messages that are combined in or included in a message data set BS1, BS2 can be specified by a predetermined packet size.

The central computing unit 11a can transmit the message data sets BS1, BS2 to a data collection unit 13 of the motor vehicle 10 for transmission to the backend server 20. The data collection unit 13 can be referred to as a so-called Online Data Collector. The data collection unit 13 can form a stand-alone control unit with respect to the other functional units 11 of the motor vehicle 10. Alternatively, the data collection unit 13 may be included, for example, as a module of the central computing unit 11a.

The data collection unit 13 can capture the respective message data set BS1, BS2 and transmit it to the backend server 20 for processing in a processing signal V. For this purpose, the motor vehicle 10 and the backend server 20 can be connected to each other, for example, in a wireless or cordless communication link 30. It can also be a mobile radio connection, for example. For wireless data transmission, the data collection unit 13 comprises a communication unit 14, which in this case is designed, for example, as a mobile radio module. A corresponding communication unit 23, for example a corresponding mobile radio module, forms part of a data processing device 21 of the backend server 20. The communication units 14, 23 can form a communication interface for the motor vehicle 10 and the backend server 20.

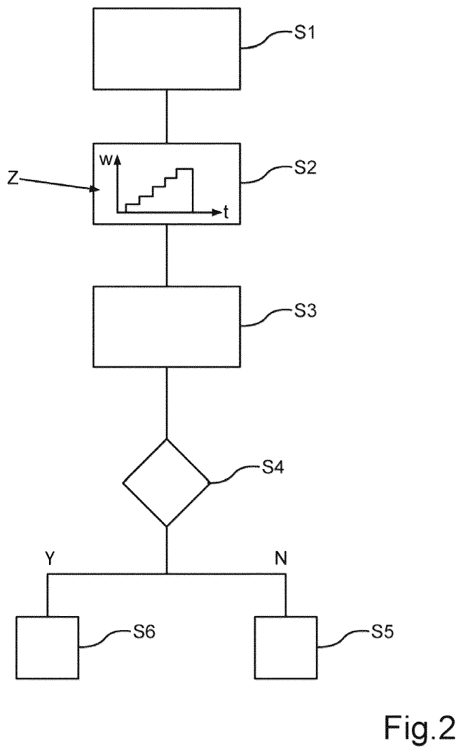

The data processing device 21 can be used for processing the processing signal V or the messages contained therein. The processing can comprise, for example, evaluation and/or storing. For storing, the backend server 20 can comprise, for example, as shown in FIG. 1, a storage device, that is, a data store 24. For evaluation, the data processing device 21 can comprise, for example, a computing unit 22, such as a microcontroller. In addition to the processing function, the data processing device 21 can also provide a function for verifying the goodness or quality of the data transmission in the system 1. Thus, errors can be detected in the data transmission on a data link in the motor vehicle 10 and/or on a data link between motor vehicle 10 and backend server 20. How this function can be implemented is described in more detail in the following with reference to FIG. 2.

FIG. 2 shows a schematic method flowchart for a method for operating the data processing device 21, an example of which has been described above. The data processing device 21 can be used to carry out a method for generating an indicator for indicating the quality of the wireless data transmission between the motor vehicle 10 and the backend server 20.

In operation S1 of the method, the processing signal V is first detected by the data processing device 21. By the computing unit 22, the processing signal V can be evaluated and, for example, the respective message data sets BS1, BS2 isolated or defined. Then, the method can be continued in operation S2.

In operation S2, a current receiver message count is determined according to a number of messages of the respective message data set BS1, BS2 transmitted to the backend server 20. This means that the computing unit 22 can, for example, read out or calculate how many messages are present in the respective message data set BS1, BS2. In addition to the message data sets BS1, BS2 currently being transmitted, (chronologically) previously transmitted message data sets BS1, BS2 can also be taken into account. Thus, it is possible to ascertain how many messages have actually already been transmitted over the communication link 30, in particular within a predetermined data transmission interval of the system 1. For example, the data transmission interval can be a time interval between a start time (activation or restart) of the motor vehicle 10 and the current time. This can therefore indicate an operating period of the motor vehicle 10. Then, the method is continued in operation S3.

In operation S3, for example, a reference message count is determined by the computing unit 22. The reference message count value is obtained in accordance with the previously known periodicity of consecutive messages, which are provided periodically in the transmitter by the assigned functional unit 11 by the respective message signal B1, B2. The reference message count can thus indicate how many messages should have been present in the respective transmitted message data set BS1, BS2 and should therefore have been transmitted to the backend server 20 within the data transmission interval.

To determine the reference message count, the data processing device 21 of the motor vehicle 10 can detect, for example, the start time of the data transmission interval and the packet size of the respective message data set BS1, BS2. These can be provided, for example, by the motor vehicle 10 in the processing signal V. This can be carried out once, for example, initially when transmitting the first processing signal V in the data transmission interval. Alternatively, this information can be sent along with each transmission. As a result, the backend server 20 can determine the cycle time or periodicity for each message signal B1, B2 in the motor vehicle 10. Thus, the backend server 20 itself can count how many messages should be included in the transferred message data set BS1, BS2. The backend server 20 can thus form a message counter.

A predefined counting scheme can be specified for the message count values. For example, a value range from 0 to 15 can be specified for the message count values. As soon as the maximum value of 15 is reached, the counting process is restarted from 0. In FIG. 2 at operation S2, an example counter signal Z for a corresponding message counter is shown. The time is represented on the abscissa (x-axis), while the ordinate (y-axis) represents the respective message count. As shown in FIG. 2, the count signal Z can be formed as a stepped signal between a minimum value, for example 0, and the maximum value, for example 15, wherein each step corresponds to a new message, and the count value W is increased by exactly the value 1 with each message. As shown in FIG. 2, the steps of the count signal are symmetrical, which illustrates that for an intact message transmission the messages are detected at regular time intervals.

The respective message counts can be formed, for example, as a mean value or as a sum of the data size designated for a specific number of messages. For example, the mean value or the sum can be formed over a window of 16 consecutive messages. Due to the periodic sequence of the message counter, i.e. the messages, it does not matter where or when the process starts as long as the summation is performed or the mean value is formed over the respective period, i.e. the predetermined number of messages. For the values from 0 to 15 for the message counter, the sum must equal 120 in total or the mean value must equal 7.5 if no messages have been lost during acquisition or processing.

Then, the method is continued in operation S4.

In operation S4 it is checked whether the receiver message count matches the reference message count according to a predefined verification criterion. For example, according to the verification criterion it can be checked whether the message counts are different by n % or contain jumps of n % relative to one another (n=number of messages). Alternatively, the matching criterion may include, for example, the condition that the message count values exactly match, i.e. they should have the same value.

The verification criterion is therefore, for example, a rule or condition that specifies whether the compared message counts are classified as matching or non-matching. For example, the verification criterion can set a limit for a maximum difference or a maximum percentage deviation of the two message counts. Preferably, for example, the verification criterion can only indicate a match if the message counts have exactly the same value. Otherwise, the message counts are classified as non-matching.

If the check is negative, i.e. the matching criterion is not met (N), this is an indicator of unstable behavior or processing of the information. This means that the quality of the data processing or data transmission in the system 1 cannot be guaranteed. If this is the case, the method is continued in operation S5.

In operation S5, a negative indicator is then generated with regard to the data transmission quality, indicating that the data transmission contains errors. Then, for example, an error message or warning message can be provided by the backend server 20 to the motor vehicle via the communication link 30. In addition or alternatively, the data associated with the data transmission containing errors can be deleted from the backend server 20.

On the other hand, if the verification is positive, i.e. the verification criterion is met (Y), the method is continued in operation S6. In operation S6 a positive indicator is generated. This indicates that the data transmission was error-free or correct. The transmitted data can thus be successfully used for further processing by the backend server 20.

If the positive indicator has been generated, it can be assumed that all pre-aggregated or previously collected data from the motor vehicle 10 are also usable, even if individual data items or messages on the transmission link have been lost. In addition, it can be assumed that, for example, all other useful signals that were transmitted with the processing signal V in the window under consideration, i.e. the message data set, are error-free. The useful signals may involve, for example, additional information or meta-information relating to the messages that were transmitted together with the processing signal or as part of the processing signal.

As an alternative to the exemplary embodiments described in the figures, for example, the motor vehicle can comprise the data processing device 21. In that case the reference message count can be transmitted in particular from the motor vehicle 10 to the backend server 20 as part of the processing signal V.

Overall, the exemplary embodiments show a method for generating an indicator for the data quality and data integrity of an online data collector by exploiting periodic signals in the vehicle.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-9. (canceled)

10. A method generating an indicator for indicating quality of a data transmission between a transmitter and a receiver coupleable to each other, comprising:
detecting a processing signal, which is transmissible from the transmitter to the receiver for processing, the processing signal being based on a data collection unit of the transmitter, which acquires a respective message data set of at least one functional unit of the transmitter, the respective message data set including at least one message which indicates a state of a respective functional unit;
determining a current receiver message count depending on a number of messages in the respective message data set transmitted to the receiver;
verifying whether a receiver message counter corresponds to a predetermined reference message count according to a predetermined verification criterion, the predetermined reference message count being obtained as a function of a previously known periodicity of successive messages, which are provided periodically by the respective functional unit which is associated with the transmitter, and
based on the receiver message counter being verified, providing the indicator that indicates the quality of the data transmission based on the processing signal.

11. The method as claimed in claim 10, wherein the data transmission is a wireless data transmission, and
the predetermined reference message count is determined by the transmitter and the predetermined reference message count is part of the processing signal for transmitting to the receiver.

12. The method as claimed in claim 10, wherein a value of the predetermined reference message count is determined by the receiver, additionally depending on a previously known start time of a start of a message transmission by the respective functional unit associated with the transmitter and on a previously known packet size, which indicates a number of transmitted messages in the processing signal.

13. The method as claimed in claim 10, wherein a respective message count is obtained as a sum of a predetermined number of messages.

14. The method as claimed in claim 11, wherein a respective message count is obtained as a sum of a predetermined number of messages.

15. The method as claimed in claim 12, wherein a respective message count is obtained as a sum of a predetermined number of messages.

16. The method as claimed in claim 10, wherein a respective message count is obtained as a mean value of a sum of a predetermined number of messages.

17. The method as claimed in claim 11, wherein a respective message count is obtained as a mean value of a sum of a predetermined number of messages.

18. The method as claimed in claim 12, wherein a respective message count is obtained as a mean value of a sum of a predetermined number of messages.

19. The method as claimed in claim 10, wherein the transmitter is a motor vehicle and the receiver is a backend server.

20. A data processing device to generate the indicator for indicating the quality of the data transmission between the transmitter and the receiver which is associated with the transmitter, wherein the data processing device is designed to carry out the method as claimed in claim 10.

21. A receiver having the data processing device as claimed in claim 20, wherein the data processing device is designed to receive the processing signal from the transmitter by a wireless data transmission.

22. A transmitter having a respective at least one functional unit and the data processing device as claimed in claim 20, wherein the data processing device comprises the data collection unit to provide the processing signal, which is designed to acquire a respective message data set of the respective functional unit in order to provide the processing signal, and the transmitter is designed to transmit the processing signal to the receiver by a wireless data transmission.

23. A system comprising the transmitter and the receiver, which are coupled to each other in a wireless communication link for the wireless data transmission, wherein the receiver is designed as claimed in claim 21 and/or the transmitter is designed as claimed in claim 22.
